(19) United States
(12) Patent Application Publication
(10) Pub. No.: US 2021/0215641 A1
(43) Pub. Date: Jul. 15, 2021

(54) METHOD AND DEVICE FOR NONDESTRUCTIVELY ACOUSTICALLY EXAMINING AT LEAST ONE REGION OF A COMPONENT OF A TURBOMACHINE FOR SEGREGATIONS

(71) Applicant: MTU Aero Engines AG, München (DE)

(72) Inventor: Joachim Bamberg, Dachau (DE)

(73) Assignee: MTU Aero Engines AG, München (DE)

(21) Appl. No.: 17/255,818

(22) PCT Filed: Jun. 18, 2019
(86) PCT No.: PCT/DE2019/000162

§ 371 Date: Mar. 25, 2021

(30) Foreign Application Priority Data
Jun. 27, 2018 (DE) 10 2018 210 500.6

(51) Int. Cl. G01N 29/04; G01N 29/06; G01N 29/26; G01N 29/48

(52) U.S. Cl. CPC G01N 29/043; G01N 29/0609; G01N 29/262; G01N 2291/2693; G01N 2291/044; G01N 2291/106; G01N 29/48

(57) ABSTRACT

The invention relates to a method for nondestructively acoustically examining at least one region of a component of a turbomachine, wherein at least the following steps are performed: a) arranging a transmitter comprising a plurality of individual oscillators on the region of the component to be examined, b) introducing at least one ultrasound beam into the component by means of the transmitter, c) receiving at least one ultrasound beam reflected by the component by means of a receiver comprising a plurality of individual receivers and d) checking, on the basis of the received ultrasound beam, whether there is a deviation in the region of the component which characterizes a segregation. The invention further relates to a device for carrying out a method of this type.

### BACKGROUND OF THE INVENTION

The invention relates to a method and a device for nondestructively acoustically examining at least one region of a component of a turbomachine for segregations.

The term segregation refers to demixings of a metal alloy melt upon transition from the melt to the solid state, which lead to a local increase and/or decrease of certain elements within the mixed crystal of the metal alloy. Segregations therefore result in locally different material properties within a component. For example, in components of turbomachines, such as, for instance, engine disks made of nickel-based alloys, so-called “dirty white spots” are known, which, when the engine is in operation, can lead to the formation of cracks due to long-acting low-cycle fatigue loads.

It is known how to examine surfaces of components, such as, for instance, engine disks, for segregations by means of etching inspection. However, such etching inspections are not suitable for the detection of segregations that lie beneath the surface of the component and, moreover, they are detrimental to the component. With the development of modern turbomachines, such as, for example, aircraft engines, there is an increasing need for methods of inspection with which components can be inspected for flaws in a non-invasive and non-destructive manner. For non-invasive inspection, ultrasound technologies have meanwhile been employed routinely in many cases. In this case, an ultrasound beam is produced and introduced in a focused manner into a volume element of the component. The reflected echo signals are received and the amplitudes of the individual signals are summed up, as a result of which the signal-to-noise ratio is improved. The summed-up signal is then used to inspect for any anomalies.

However, particularly hidden segregations, that is, segregations that lie in the interior of a component, could not hitherto be detected by this method, because, in this form of ultrasound inspection, echo signals of the segregations vanish in the structural noise.

### SUMMARY OF THE INVENTION

An object of the present invention is to create a method for nondestructively acoustically examining at least one region of a component of a turbomachine, which makes possible an identification of anomalies lying in the interior of the component. A further object of the invention is to create a corresponding device for carrying out such a method.

The objects are achieved in accordance with a method as well as by a device in accordance with the present invention. Advantageous embodiments with expedient further developments of the invention are presented in the respective dependent claims, wherein advantageous embodiments of the method are to be regarded as advantageous embodiments of the device and vice versa.

A first aspect of the invention relates to a method for nondestructively acoustically examining at least one region of a component of a turbomachine for segregations. An identification of segregations lying in the interior of the component is made possible in accordance with the invention in that at least the following steps are performed: a) arranging a transmitter comprising a plurality of individual oscillators on the region of the component to be examined, b) introducing at least one ultrasound beam into the component by means of the transmitter, c) receiving at least one ultrasound beam reflected by the component by means of a receiver comprising a plurality of individual receivers, and d) checking on the basis of the received ultrasound beam whether there is a deviation in the region of the component that characterizes a segregation. In other words, it is provided in accordance with the invention that, with the help of a transmitter, which may also be referred to as an ultrasound group radiator or multi-element probe, an ultrasound beam can be produced and introduced into the region of the component to be investigated. These individual transmitters can be excited individually and/or in groups in order to produce the ultrasound beam. In the simplest embodiment, two individual transmitters can be provided, so that, for example, a two-element probe composed of a central oscillator and a ring element can be used. Depending on the material characteristics at the inspected site of the component, the ultrasound beam is specifically reflected and is received as an echo signal by means of the receiver. In analogy to the transmitter, the receiver has two or more individual receivers and thereby allows a multichannel recording of measured values of the structural noise signal.

The individual wave fronts of the ultrasound beam overlap constructively and destructively in this case and expand in the component to be inspected, whereby they are reflected at segregations, cavities, cracks, inclusions, the back wall of the component, and other material boundaries, just like a conventional ultrasound wave. In contrast to the prior art, the reflected ultrasound beam is subsequently not summed up to afford a single summed-up signal, but rather is retained together with its spatial context, and is able to be individually identified and can be used to inspect for the presence of segregations. In this way, an especially reliable and nondestructive identification of segregations that also lie in the interior of the component and, if needed, of other anomalies, such as, for example, inclusions, cavities, and the like, is made possible. In general, in the scope of this disclosure, “a” or “an” is to be read as an indefinite article, that is, unless explicitly stated to the contrary, always also as “at least one.” Conversely, “a” or “an” can also be understood to mean “only one.” The method can fundamentally be carried out on newly produced components for monitoring the production process or on components that have already been installed or utilized for inspection of their state in the course of maintenance or overhaul.

In an advantageous embodiment of the invention, it is provided that, as a transmitter, a phased array transmitter and/or, as a receiver, a phased array receiver is or are used. A phased array transmitter is a transducer with an organized arrangement or array of a plurality of individual transmitters, which are excited in a predetermined sequence in order to produce the ultrasound beam. Depending on its design, such a transmitter can be arranged on the component either directly or by contact or immersion technology. The array can be, in general, a linear array, a matrix array, a circular array, or the like. For example, a plurality of or all of the individual transmitters can be excited with the same or different phases. Alternatively, one, a plurality of, or all of the individual transmitters can transmit in succession and one, a plurality of, or all of the individual receivers of the phased array receiver can receive in phase (so-called full matrix capture). By means of clocking all of the individual oscillators, it is possible in this way to examine the entire volume of the component in a high-resolution manner. The corresponding situation applies to the receiving side for a receiver that is designed as a phased array receiver. In general, transmitters and receivers can be combined into an assembly or else can be arranged apart from one another.

In a further advantageous embodiment of the invention, it is provided that, on the basis of the at least one reflected ultrasound beam, at least one false color image is computed, in which the colors of the false color image correspond to individual amplitudes of the ultrasound beam, and, on the basis of the at least one false color image, it is checked whether a deviation that characterizes a segregation is present in the region of the component. In the scope of the present invention, a false color image is understood to mean a matrix made up of individual dots or pixels, in which the values of the individual pixels correspond to respective individual amplitudes of the ultrasound beam and can be represented by assigned color values. For example, the color “white” can be assigned to the value 0, the color “black” to the value 1, the color “blue” to the value 0.5, etc., with the invention not being limited to a specific embodiment in regard to the color coding. Likewise, for color coding, the individual amplitudes can be assigned to brightness levels of an individual hue of color. In a false color image in accordance with the present invention, the individual amplitudes of the ultrasound beam are thus not summed up to afford a single value, but rather are retained together with their spatial context and can be individually identified and thus analyzed. This false color image is then used to inspect for anomalies in the examined region of the component. In the simplest case, the inspection can be conducted, for example, by comparison of the false color images with a computed reference image and/or by comparison with a reference image that was determined on the basis of a reference component.

In a further advantageous embodiment of the invention, it is provided that the at least one false color image in step d) is computed as a grayscale image, with the gray levels of the grayscale image corresponding to individual amplitudes of the reflected ultrasound beam. In a grayscale image, each pixel or each image dot can assume, for example, 256 different color values or brightness values from 0 (black or white) to 255 (white or black), which are assigned to corresponding amplitude values of the ultrasound beam.

In a further advantageous embodiment of the invention, a plurality of false color images are combined to create an image stack, which is used for the inspection in step d). In this way, an especially reliable identification of hidden anomalies is made possible.

In an advantageous embodiment of the invention, it is provided that, in step a), as the transmitter, a two-dimensional matrix transmitter with X*Y individual transmitters and/or, in step c), a two-dimensional matrix receiver with X*Y individual receivers is or are used, where X and Y are chosen, independently of each other, from the set of whole positive numbers Z≥2. In other words, it is provided that the transmitter or the receiver comprises individual transmitters or individual receivers that are arranged not linearly, but rather over a two-dimensional area along an X axis and a Y axis, where the number X of the individual transmitters/individual receivers along the X axis can be chosen independently of the number Y of the individual transmitters/individual receivers along the Y axis. For example, X and Y can be chosen to be identical or different and each can be 2, 3, 4, 5, 6, 7, 8, 9, 10, 11, 12, 13, 14, 15, 16, or more. Furthermore, it can fundamentally be provided that the array of the transmitter differs from the array of the receiver, whereby, as a rule, the two arrays are preferably chosen to be identical. An array with 10*10 individual transmitters/individual receivers would accordingly comprise 100 individual transmitters/individual receivers, while an array with 10*11 individual transmitters would comprise 110 individual transmitters/individual receivers, an array with 11*11 would comprise 121 individual transmitters/individual receivers, etc. In this way, it is possible to take into account the size or the volume of the region to be investigated in an optimal manner, whereby all possible array embodiments can be taken into account via a correspondingly dimensioned false color image.

In an advantageous embodiment of the invention, it is provided that, in step b), the ultrasound beam is produced and introduced with a frequency between 500 kHz and 20 MHz. A frequency between 500 kHz and 20 MHz is understood to be, for example, a frequency of 500 kHz, 550 kHz, 600 kHz, 650 kHz, 700 kHz, 750 kHz, 800 kHz, 850 kHz, 900 kHz, 950 kHz, 1000 kHz, 1.5 MHz, 2.0 MHz, 2.5 MHz, 3.0 MHz, 3.5 MHz, 4.0 MHz, 4.5 MHz, 5.0 MHz, 5.5 MHz, 6.0 MHz, 6.5 MHz, 7.0 MHz, 7.5 MHz, 8.0 MHz, 8.5 MHz, 9.0 MHz, 9.5 MHz, 10.0 MHz, 10.5 MHz, 11.0 MHz, 11.5 MHz, 12.0 MHz, 12.5 MHz, 13.0 MHz, 13.5 MHz, 14.0 MHz, 14.5 MHz, 15.0 MHz, 15.5 MHz, 16.0 MHz, 16.5 MHz, 17.0 MHz, 17.5 MHz, 18.0 MHz, 18.5 MHz, 19.0 MHz, 19.5 MHz, or 20.0 MHz as well as corresponding intermediate values. Alternatively or additionally, it is provided that the ultrasound beam is introduced into a surface region of the component that has an area between 1 mm² and 1000 mm². Areas between 1 mm² and 1000 mm² are understood in the present case to be an area of 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², 200 mm², 300 mm², 400 mm², 500 mm², 600 mm², 700 mm², 800 mm², 900 mm², or 1000 mm² as well as corresponding intermediate values, such as, for example, 10 mm², 11 mm², 12 mm², 13 mm², 14 mm², 15 mm², 16 mm², 17 mm², 18 mm², 19 mm², 20 mm², etc. Alternatively or additionally, it is provided that the ultrasound beam is introduced at a depth of introduction between 1 mm and 100 mm into the component. Depths of introduction between 1 mm and 100 mm are understood in the present case to be a depth of introduction of 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, 76 mm, 77 mm, 78 mm, 79 mm, 80 mm, 81 mm, 82 mm, 83 mm, 84 mm, 85 mm, 86 mm, 87 mm, 88 mm, 89 mm, 90 mm, 91 mm, 92 mm, 93 mm, 94 mm, 95 mm, 96 mm, 97 mm, 98 mm, 99 mm, or 100 mm. It is fundamentally possible for greater depths of introduction to be provided as well, provided that the reflected signal still allows a reliable analysis. In this way, it is possible to take into account the material properties and the geometry of the component in a targeted manner during the inspection.

Further advantages ensue in that the reflected ultrasound beam is received in step c) by means of a transmitter as a receiver and/or by means of a receiver that is separate from the transmitter. In other words, it is provided that the transmitter is also used as a receiver or that the transmitter and the receiver are spatially separated elements, which can be arranged in separate housings or in a common housing. In this way, it is possible to take into account the individual geometry of the component to be inspected in an optimal manner.

Further advantages ensue in that at least the steps b) to d) are repeated a number of times. In this way, it is possible to determine a time course of the ultrasound beam for one and the same region of inspection or for one and the same inspected volume of the component and to use it for the inspection in that, for example, a plurality of false color images are determined and analyzed and/or in that the ultrasound signals (structural signatures) are supplied to a neuronal network for analysis. Alternatively or additionally, it is possible to inspect a plurality of regions of the component for segregations and, if needed, to check for further anomalies, whereby, for this purpose, if needed, the transmitter in accordance with step a) is also moved in relation to the component in order to introduce ultrasound into additional regions for inspection.

Further advantages ensue in that a plurality of ultrasound beams are introduced in different directions into the component and/or in that a plurality of ultrasound beams are introduced in different depths of the component and/or in that, for a plurality of ultrasound beams, different focal point sizes are adjusted. By way of the parameters of angle, focal distance, and focal point size, it is possible to adapt the ultrasound beam dynamically such that a single transmitter/receiver is able to inspect the entire component to be inspected from different perspectives. To this end, the ultrasound beam parameters are altered individually or in any desired combination, so that the component can be inspected in a very short period of time at different angles with a plurality of focal depths and/or with different accuracy of detail.

Further advantages ensue in that the inspection in step d) is carried out by means of an artificial neuronal network, which, in particular, has been trained by a deep learning method. Artificial neuronal networks are networks made up of artificial neurons and are suitable especially well for the analysis of the false color image or images. In deep learning, a computer model is trained to perform classification tasks, for example, directly from the false color image or images that afford a representation of the acoustic data. Alternatively or additionally, ultrasound signals (structural signatures) can be used directly or in processed form to train the network. For this purpose, it is possible, for example, to use ultrasound signals that are acquired on a defined test object or flawed part having one coarse grain region or a plurality of local coarse grain regions. Such a qualified test object with artificial segregations, which, for example, can be characterized by use of x-ray CT, allows an especially rapid and reliable training of a neuronal network. A deep learning model that is employed can, if needed, also be trained at first on the basis of comprehensive sets of classification data and on the basis of network architectures.

In a further advantageous embodiment of the invention, it is provided that a single-layer or multilayer feedforward network and/or a recurrent network is or are used. In this way, it is possible to optimally take into account the complexity of the inspection task, which can depend on, among other things, the geometry and structure of the component. Alternatively or additionally, it is provided that the neuronal network is trained on the basis of at least one unflawed part and/or at least one flawed part. In this case, an unflawed part is understood to be a component that, in a separate, not necessarily acoustic inspection, has already been found to be “in order” and corresponds to the component to be inspected to an adequate degree at least in terms of the meaningfulness of the inspection result. A flawed part is accordingly understood to be a component that, to an adequate degree, corresponds to the component to be inspected and has one known or deliberately produced anomaly or a plurality of known or deliberately produced anomalies, for which it is suspected that they could also arise in the component to be inspected. For example, artificially introduced segregations can be present in the flawed part and can be used for training the model.

In a further advantageous embodiment of the invention, it is provided that time signals of the at least one ultrasound beam are scaled in the human hearing range and/or that the at least one ultrasound beam is analyzed by means of a sound event classification method. In this way, it is possible to analyze the ultrasound beam signal by use of signal processing and signal classification methods taken from hearing, speech, and audio technology, that is, in the frequency range between about 20 Hertz and about 22 kHz perceptible to humans.

An improved monitoring for a user carrying out the inspection method is made possible in a further embodiment of the invention in that at least one false color image and/or one inspection result is displayed by means of a display device. In the case of a plurality of false color images, they can also be displayed as a stack of images. Furthermore, it can be provided that identified anomalies can be highlighted in at least one false color image. This can be done through the use of sufficiently contrast-rich signal colors, by animations, or by other optical, haptic, and/or acoustic indications to the user. Furthermore, it can be provided that the false color image and/or an identified anomaly is displayed in a 2D/3D model of the inspected component, which, if needed, can be transparent or semitransparent, with its correct localization in the component. This allows an especially simple decision to be made as to whether, in the case of an identified anomaly, the component nonetheless meets the required specifications or whether it can or cannot be repaired.

The method according to the invention can also be present in the form of a computer program (product), which implements the method on a control unit when it is executed on the control unit. Likewise, it is possible to provide an electronically readable data carrier in which electronically readable control information is stored and which comprises at least one described computer program product and is designed in such a way that it carries out the method according to the invention when the data carrier is used in a control unit.

A second aspect of the invention relates to a device for carrying out a method in accordance with the first aspect of the invention. For this purpose, the device according to the invention comprises at least one transmitter comprising a plurality of individual oscillators and can be arranged on at least one region of the component to be examined, and by means of which at least one ultrasound beam can be introduced into the component, at least one receiver that comprises a plurality of individual receivers for receiving at least one ultrasound beam reflected by the component, and at least one computing unit that is coupled to the receiver for the exchange of data and is designed to inspect at least one two-dimensional false color image on the basis of the at least one reflected ultrasound beam as to whether there is a deviation that characterizes a segregation in the region of the component. The device according to the invention thereby makes possible an identification of segregations lying in the interior of the component to be inspected and, optionally, of further anomalies. The expression “designed to” is understood in the scope of the present disclosure to refer to a computing unit that has not only a general suitability for carrying out the corresponding part of the method in accordance with the first aspect of the invention, but rather is designed specifically by way of hardware-side and/or software-side measures to carry out the respective steps and also to carry them out for an intended use. The computing unit usually has a processor device that is composed of at least one microprocessor and/or one microcontroller. Furthermore, the processor device can have a program code that, when it is executed by the processor device, is designed to carry out one embodiment of the method in accordance with the first aspect of the invention. The program code can be stored in a data memory unit that is coupled to the processor device. Further features and the advantages thereof may be taken from the descriptions of the first aspect of the invention, with advantageous embodiments of each aspect of the invention to be regarded as advantageous embodiments of the respective other aspect of the invention.

In an advantageous embodiment of the invention, it is provided that the transmitter is a matrix transmitter, in particular a phased array transmitter and/or that the receiver is a matrix receiver, in particular a phased array receiver.

In a further advantageous embodiment of the invention, it is provided that the computing unit is designed to compute at least one two-dimensional false color image on the basis of the at least one reflected ultrasound beam and, on the basis of the at least one false color image, to inspect whether there is a deviation that characterizes a segregation in the region of the component and/or that the computing unit is designed to inspect on the basis of the at least one reflected ultrasound beam by means of an artificial neuronal network, which, in particular, has been trained by a deep learning method, whether there is a deviation that characterizes a segregation in the region of the component.

In an advantageous embodiment of the invention, the device has a display device for displaying at least one false color image and/or an inspection result. Preferably, the entire device is designed as a portable instrument, preferably with its own electric power supply, so that the ultrasound inspection, data processing, examination, and image display can proceed without additional means of assistance directly on the component or on the turbomachine.

A further aspect of the invention relates to a computer program, which can be loaded directly into a memory of a computing unit of a device in accordance with the second aspect of the invention and contains program means for performing the steps of the method in accordance with the first aspect of the invention when the program is run in the computing unit.

A further aspect of the invention relates to an electronically readable data carrier containing electronically readable control information stored on it, which comprises at least one computer program in accordance with the preceding aspect of the invention and is designed in such a way that, when the data carrier is used in a computing unit of a device in accordance with the second aspect of the invention, it can carry out a method in accordance with the first aspect of the invention.

### BRIEF DESCRIPTION OF THE DRAWING FIGURES

Further features of the invention ensue from the claims, the figures, and the description of the figures. The features and combinations of features that are mentioned above in the description as well as the features and combination of features that are mentioned below in the description of the figures and/or shown in the figures alone can be used not only in the respectively presented combination, but also in other combinations, without leaving the scope of the invention. Accordingly, embodiments of the invention that are not explicitly shown and explained in the figures, but ensue and can be created by separate combinations of features from the explained embodiments are to be regarded as included and disclosed. Also to be regarded as embodiments and combinations of features are accordingly those that do not have all the features of an originally formulated independent claim. In addition, embodiments and combinations of features that go beyond the combinations of features described in reference back to the claims or else depart from them are to be regarded as being disclosed, in particular by the above-described embodiments. Here:

FIG. 1 shows a schematic sectional view of a component that is designed as a turbine disk, on which a nondestructive, acoustic examination is carried out;

FIG. 2 shows a schematic illustration of the production of an ultrasound beam;

FIG. 3 shows a schematic illustration of the receiving of an ultrasound beam that has been reflected from a region of the component;

FIG. 4 shows an exemplary false color image with amplitude values of the reflected ultrasound beam assigned to individual pixels;

FIG. 5 shows a time signal, by way of example, along a depth region of the component;

FIG. 6 shows a detailed enlargement of the region VI shown in FIG. 5; and

FIG. 7 shows a stack of images composed of a plurality of false color images that follow one another in succession.

### DESCRIPTION OF THE INVENTION

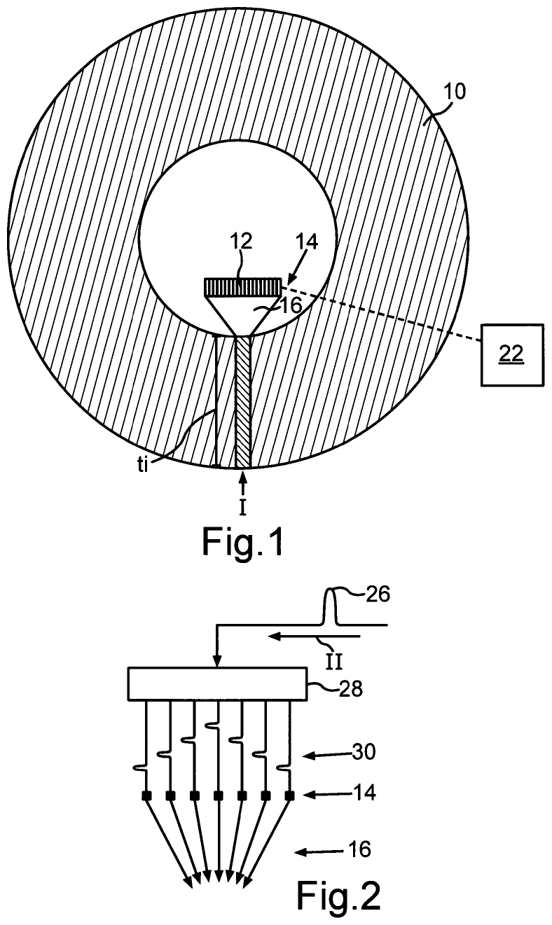

FIG. 1 shows a schematic sectional view of a component 10, which is designed as a turbine disk of an aircraft engine, on which a nondestructive, acoustic inspection for the presence of anomalies, such as, for example, segregations in the material of the component 10, is carried out. For this purpose, a transmitter 12 with an array of individual transmitters 14 is arranged on a region Ito be investigated of the component 10. In the present case, the transmitter 12, which can be a phased array transmitter, has 121 individual transmitters 14, which are arranged in the form of a 2D matrix in a square X*Y grid with X, Y=11. Subsequently, at least one ultrasound beam 16 is produced by means of the transmitter 12 and introduced into the component 10 in a focused manner. The diameter of the ultrasound beam 16 is typically adjusted to be about 1 mm to about 3 mm. In this case, the depth of introduction ti can be chosen to be constant or variable as needed. In one exemplary embodiment, the depth of introduction or the depth range ti is 10 mm. For a speed of sound of typically about 6000 m/s, this corresponds to about 3.3 μs transit time to a depth of 10 mm (transit time=forward transit and back transit). For a typical digitization rate of 100 megasamples per second, this results in 330 amplitude values. Alternatively or additionally, however, it is also fundamentally possible to inspect the entire region I of the component 10 from the inner side to the outer side of the turbine disk 10.

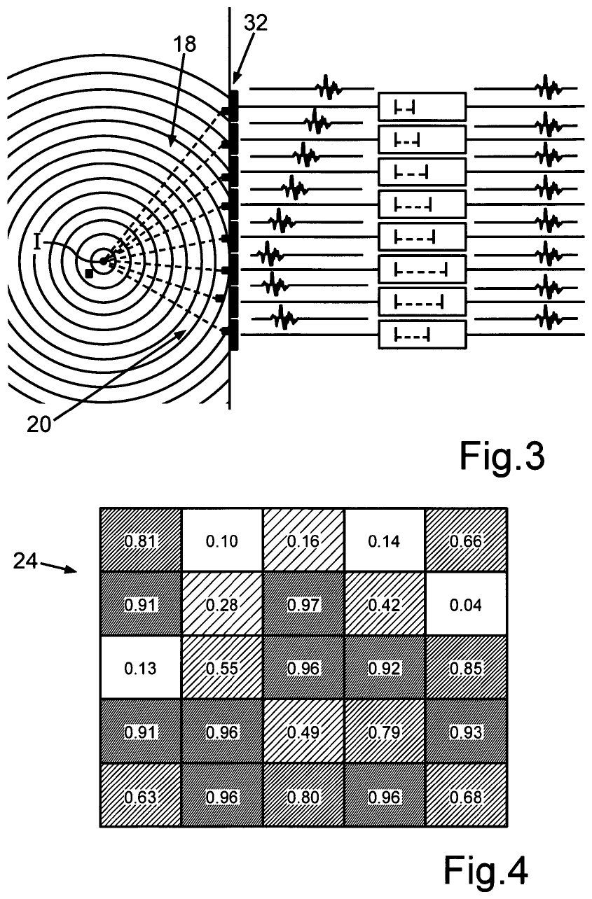

With the help of the transmitter 12, which, in the present case, is designed as a receiver 20, such as, for example, as a phased array receiver, also for receiving at least one ultrasound beam 18 (see FIG. 3) that has been reflected by the component 10, the at least one ultrasound beam 18 that is reflected by the component 10 is received and transmitted to a computing unit 22 for further analysis. The transmitting/receiving area can be, for example, 15 mm*15 mm=225 mm².

In one embodiment of the invention, on the basis of the ultrasound beam 18, the computing unit 22 computes at least one false color image 24 (see FIG. 4), with colors of the false color image 24 corresponding to individual amplitudes of the received ultrasound beam 18. In other words, in the present example, there occurs a conversion of 11*11 reflected ultrasound amplitudes to afford the 2D false color image 24, which can be a grayscale image, for example. For the above-mentioned depth of introduction of 10 mm, by way of example, a digitization rate of 100 megasamples per second and a matrix of size 11*11, by way of example, a 2D false color image would have a size of 330 columns and 121 rows. Large amplitudes can be characterized here by using dark color values, while small amplitudes are characterized using light color values. Of course, it is also possible to provide a converse or deviating coloration. A summation of the individual amplitudes, which is conventional in the prior art, does not take place. In general, it can be provided that, by way of a corresponding offset, positive and negative amplitude values can be depicted exclusively in a positive region or characterized exclusively by positive numerical values, as a result of which unreliable negative values for individual image dots can reliably be prevented. Alternatively, however, other suitable depiction algorithms are conceivable.

In one exemplary embodiment, on the basis of the at least one false color image 24, it is checked by means of the computing unit 22 whether a deviation that characterizes a segregation or other anomaly is present in the examined region I of the component 10. Alternatively or additionally to the false color image 24, the received ultrasound beam 18 can be used for inspection either directly or after a scaling from the megahertz region to the kilohertz region. The inspection can be conducted, for example, by means of deep neuronal networks or by a deep learning model. The neuronal networks or the deep learning model or models employed can fundamentally be trained beforehand by use of data acquired for good parts and flawed parts. The inspection time is extremely short, because the ultrasound beams 16, 18 can be produced and processed at the same time or in very short intervals of time. Accordingly, the entire component 10 can be inspected completely in a correspondingly short period of time. Likewise, it can be provided that a so-called sound event classification is used to process the ultrasound beam 18 and to inspect for the presence of segregations. For this purpose, as already mentioned, the time signals of the ultrasound beam 18 are first scaled in the range of human hearing and subsequently analyzed for the presence of ultrasound signals that are typical of the structural signatures of segregations.

FIG. 2 shows a schematic illustration for producing an ultrasound beam 16. In this case, a pulse 26 from a pulse generator (not shown) is produced and guided according to arrow II to a fundamentally optional delay circuit 28, which, by way of phase modulation, produces a plurality of time-delayed pulses 30, which are guided to the individual piezoelectric transmitters 14. Owing to the pulses 30, the individual transmitters 14 are compressed at different points in time and, after the drop in voltage, spring back to their original shape normally after less than a microsecond. They thereby produce a mechanical energy impulse, which, in turn, produces an ultrasound wave. The individual ultrasound waves form the ultrasound beam 16, which, if needed, is emitted in a focused manner in the direction of the region Ito be inspected. Through in-phase controlled introduction onto a small inspected volume of the component 10, even small flawed sites (segregations, pores, cracks, etc.) can be detected.

In an alternative embodiment, current is applied to only a single individual transmitter 14 in each case in order to a emit an ultrasound pulse. The reflected ultrasound pulse is received by all individual receivers 32 in an in-phase manner (so-called full-matrix capture). By means of clocking of all individual transmitters 14, it is possible in this way to inspect the entire volume of the component 10 in a high-resolution manner, with the inspection requiring more time in comparison to the other embodiment.

FIG. 3 shows a schematic illustration of receiving an ultrasound beam 1 that has been reflected from the examined region I of the component 10. The individual ultrasound waves of the reflected ultrasound beam 18 are received by respective individual receivers 32 of the receiver 20, digitized, and guided to the computing unit 22, where, if needed, they are converted into a false color image 24 and/or transmitted to a neuronal network for analysis.

FIG. 4 shows, by way of example, a false color image 24 with amplitude values of the reflected ultrasound beam 18 assigned to individual pixels. The false color image 24 corresponds, by way of example, to a result that was obtained with the help of a 2D matrix transmitter 12 with 5*5 individual transmitters 14 or a 2D matrix receiver 20 with 5*5 individual receivers 32. It can be seen that small amplitudes, such as, for example, 0.04, were assigned to light color values, while large amplitudes, such as, for example, 0.96, were assigned to dark color values. Furthermore, it can be seen that not only the amplitude values, but also the local context of the individual ultrasound waves that have formed the ultrasound beams 16, 18 are retained as analyzable information. The false color image 24 can be displayed to an inspector of the component 10.

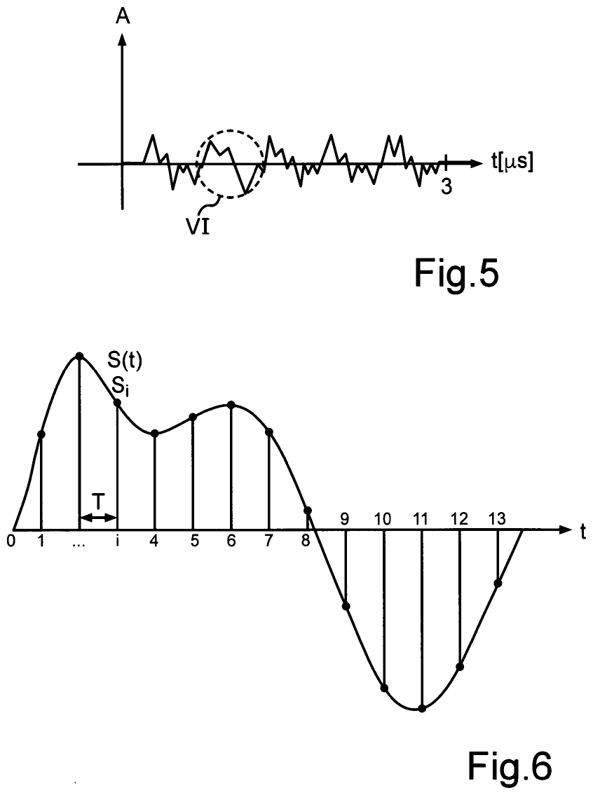

FIG. 5 shows, by way of example, a time signal along a depth range ti of the component over a time t of 3 μs, with the depth range ti being between 0 mm and 10 mm starting from the surface of the component 10. Shown here are solely the amplitude values S(t) of a single ultrasound wave from the reflected ultrasound beam 18. FIG. 6 shows a detailed enlargement of the region VI shown in FIG. 5. The time interval indicated by T between two measured values is, in the present case, by way of example, about 10 ns, which corresponds to 100 megasamples per second.

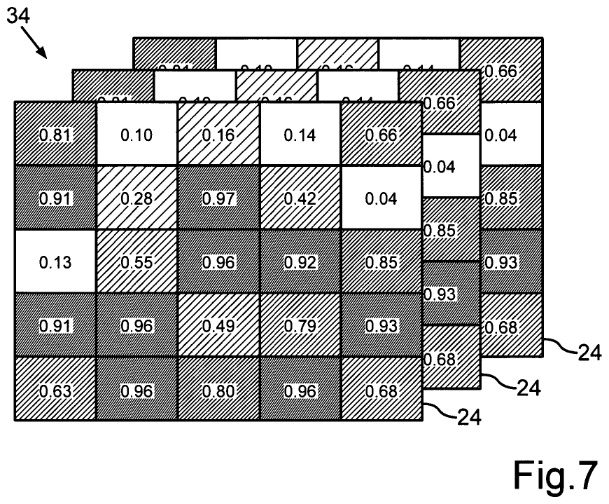

FIG. 7 shows a stack of images 34 composed of false color images 24₁, 24₂, 24₃, etc. that follow one another in succession. This allows, in addition to the incorporation of the spatial context, also taking into account the spectral composition of the individual ultrasound waves of which the ultrasound beam 18 is composed. For example, an ultrasound beam 16 can first be produced with a frequency of 10 MHz, leading to a corresponding reflected ultrasound beam 18. Depending on the frequency of the measurement, such as, for example, 15 MHz or 20 MHz, a large number n of false color images 24 are obtained in this way and make possible a corresponding analysis and thus an especially reliable identification of segregations and other anomalies.

In a further embodiment of the invention, the following steps are carried out:

By using conventional ultrasound phased array technology (multi-element ultrasonic probe, multichannel recording of measured values), a multichannel recording of the structural noise signal of the component 10 is carried out for a direction of introduction of ultrasonic waves in the coarse-grain region that varies slightly over time. The reflected ultrasound signals (structural signatures) are fed to a neuronal network. The neuronal network was trained beforehand by means of deep learning to recognize the signature of known segregations. For this purpose, a test object with many defined local coarse-grain regions was used. The ultrasound beams are scaled (MHz→KHz) and classified and analyzed by use of a sound event classification method in the human hearing range.

The parameter values given in the documentation in order to define process and measuring conditions for the characterization of specific properties of the subject of the invention are also to be regarded as included in the scope of deviations, such as, for example, those due to errors in measurement, system errors, weighing errors, DIN tolerances, and the like.

1. A method for nondestructively acoustically examining at least one region of a component of a turbomachine for segregations, comprising at least the steps
a) arranging a transmitter comprising a plurality of individual oscillators on the region of the component to be examined;
b) introducing at least one ultrasound beam into the component by the transmitter;
c) receiving at least one ultrasound beam reflected by the component by a receiver comprising a plurality of individual receivers; and
d) checking, on the basis of the received ultrasound beam, whether there is a deviation in the region of the component that characterizes a segregation.

2. The method according to claim 1, wherein, as transmitter, a phased array transmitter and/or, as a receiver, a phased array receiver is used.

3. The method according to claim 1, wherein, on the basis of the at least one reflected ultrasound beam, at least one false color image is computed, wherein colors of the false color image correspond to individual amplitudes of the ultrasound beam, and wherein, on the basis of the at least one false color image, it is checked whether a deviation that characterizes a segregation is present in the region of the component.

4. The method according to claim 1, wherein, in step a), as transmitter, a two-dimensional matrix transmitter with X*Y individual transmitters and/or, in step c), as receiver, a two-dimensional matrix receiver with X*Y individual receivers are used, wherein X and Y are chosen, independently of each other, from the set of whole positive numbers Z≥2.

5. The method according to claim 1, wherein, in step b), the ultrasound beam is produced and introduced with a frequency between 500 kHz and 20 MHz, and/or wherein the ultrasound beam is introduced into a surface region of the component with an area between 1 mm² and 1000 mm², and/or wherein the ultrasound beam is introduced into the component in a depth of introduction between 1 mm and 100 mm.

6. The method according to claim 1, wherein at least the steps b) to d) are repeated multiple times.

7. The method according to claim 6, wherein a plurality of ultrasound beams are introduced in different directions into the component, and/or wherein a plurality of ultrasound beams are introduced in different depths of the component, and/or wherein different focal point sizes are adjusted for a plurality of ultrasound beams.

8. The method according to claim 3, wherein a plurality of false color images are combined into a stack of images which is used for the examination in step d).

9. The method according to claim 1, wherein the examination in step d) is carried out an artificial neuronal network, which has been trained by a deep learning method.

10. The method according to claim 9, wherein a one-layer or multilayer feedforward network and/or a recurrent network is used, and/or wherein the neuronal network is trained on the basis of at least one unflawed part and/or at least one flawed part.

11. The method according to claim 1, wherein time signals of the at least one ultrasound beam are scaled in the human hearing range, and/or wherein the at least one ultrasound beam is analyzed by a sound event classification method.

12. The method according to claim 1, further comprising the steps of:
providing at least one transmitter that comprises a plurality of individual oscillators and that can be arranged on at least one region of the component to be examined, and at least one ultrasound beam is introduced into the component;
providing at least one receiver comprising a plurality of individual receivers for receiving at least one ultrasound beam that is reflected by the component; and
providing at least one computing unit that is coupled to the receiver for data exchange and that is designed configured and arranged to check on the basis of the at least one reflected ultrasound beam whether a deviation characterizing a segregation is present in the region of the component.

13. The method according to claim 12, wherein the at least one transmitter is a matrix phased array transmitter, and/or wherein the at least one receiver is a matrix phased array receiver.

14. The method according to claim 12, wherein the at least one computing unit is configured and arranged to compute at least one two-dimensional false color image on the basis of the at least one reflected ultrasound beam and, on the basis of the at least one false color image, to check whether a deviation characterizing a segregation is present in the region of the component, and/or wherein, on the basis of the at least one reflected ultrasound beam, the computing unit is configured and arranged to check by an artificial neuronal network that has been trained by a deep learning method, whether a deviation characterizing a segregation is present in the region of the component.

15. The method according to claim 12, further comprising the step of providing a display device for displaying at least one false color image and/or one inspection result.
